(19) United States
(12) Patent Application Publication
(10) Pub. No.: US 2010/0137450 A1
(43) Pub. Date: Jun. 3, 2010

(54) PROCESS FOR THE PREPARATION OF AQUEOUS FORMALDEHYDE SOLUTIONS

(75) Inventors: Heniz-Herbert Müller, Krefeld (DE); Stephan Ehlers, Dusseldorf (DE); Andreas Schlemenat, Koln (DE); Arnulf Werner, Dormagen (DE); Martin Schiffhauer, Erkrath (DE)

Correspondence Address: BAYER MATERIAL SCIENCE LLC, 100 BAYER ROAD, PITTSBURGH, PA, 15205, US

(73) Assignee: Bayer MaterialScience AG, Leverkasen (DE)

(21) Appl. No.: 12/621,588

(22) Filed: Nov. 19, 2009

(30) Foreign Application Priority Data
Nov. 29, 2008 (DE) 10 2008 059 701.5

(51) Int. Cl. C09K 3/00; A01N 35/02

(52) U.S. Cl. 514/694; 252/182.12; 252/407

(57) ABSTRACT

Aqueous formaldehyde solutions are prepared and the formaldehyde content of the aqueous formaldehyde solutions produced is determined by an online analytical method. The desired formaldehyde content can subsequently be established by addition of water so that an aqueous formaldehyde solution having a defined formaldehyde content (formalin) is obtained.

### BACKGROUND OF THE INVENTION

The invention relates to a process for the preparation of aqueous formaldehyde solutions, in which the formaldehyde content of the aqueous formaldehyde solutions obtained in the formaldehyde synthesis is determined by an online analytical method and the desired formaldehyde content can subsequently be established by the addition of water so that an aqueous formaldehyde solution having a defined formaldehyde content (formalin) is obtained.

Formaldehyde is one of the most important organic base materials in the chemical industry and is used as a starting material for polymeric resins (urea-formaldehyde resins, melamine-formaldehyde resins, phenolic resins), for polyacctals and for various organochemical products (e.g., pentaerythritol, trimethylolpropane, neopentyl glycol, methylenedianiline, hexamethylenetetramine, ethylenediaminetetraacetic acid, nitrilotriacetic acid). As well as being used as a starting material for chemical products, formaldehyde is used in the form of aqueous solutions as a disinfectant and preservative, for example, in the cosmetics industry.

On an industrial scale, formaldehyde is prepared by partial oxidation of methanol:

CH₃OH+0.5O₂→CH₂O+H₂O

The most important processes are:
(1) partial oxidation and dehydrogenation in the presence of crystalline silver with a deficiency of air at from 680 to 720° C. and with a methanol conversion of from 97 to 98%;
(2) partial oxidation and dehydrogenation in the presence of crystalline silver or silver nets with a deficiency of air at from 600 to 650° C. and with a methanol conversion of from 77 to 87% and subsequent recovery of the methanol by distillation and its return to the process; and
(3) oxidation with iron oxide/molybdenum catalysts with an excess of air and with a methanol conversion of from 98 to 99% (so-called “formox” process).

These processes are described in G. Reuss, W. Disteldorf, O. Grundler, A. Hilt “Formaldehyde” in “Ullmann's Encyclopedia of Industrial Chemistry” 5th Edition, Vol. A 11, pages 624-631, VCH Verlagsgesellschaft Weinheim 1988 and in H. R. Gerberich, G. C. Seaman “Formaldehyde” in “Kirk-Othmer Encyclopedia of Chemical Technology”, 4th Edition, Vol. 11, pages 935-939, Wiley Interscience, New York 1994.

In the various preparation processes, the formaldehyde is in each case obtained in the process in the form of an aqueous solution usually having a concentration of from 25 to 56 wt. %, based on the weight of the solution.

In both the silver contact processes and the metal oxide contact processes, the hot reaction gases, which consist substantially of the formaldehyde that has formed, unconverted methanol, water, CO₂, CO, CH₄, oxygen, hydrogen and nitrogen, are cooled after the reaction. The resulting formaldehyde is then washed with water or dilute formaldehyde solution. Washing is conventionally carried out in a plurality of stages counter-currently in an absorption column. The heat of absorption that is released is dissipated in heat exchangers via a product loop and can be used in a different location for heating.

The washing liquid is generally applied at the head of the last absorption stage. The formaldehyde concentration can roughly be adjusted via the amount of washing liquid.

In the process with complete methanol conversion, there is usually obtained in the first absorption stage an approximately 40 to 42 wt. %, based on the weight of the solution, formaldehyde solution. The formaldehyde concentration is lower in the subsequent absorption stages.

The aqueous formaldehyde solutions still contain residual amounts of methanol (about 1 wt. % in the process with complete methanol conversion). In the process with incomplete methanol conversion, the methanol content of the absorption solution is usually from 5 to 15 wt. %. In order to separate off the methanol, the methanol-containing formaldehyde solution is subsequently distilled. Formaldehyde solutions having a concentration of about 50 wt. % (from 45 to 55 wt. %) and from 0.5 to 1 wt. % methanol are then usually obtained.

In the formox process, formalin solutions having a concentration of from 37 to 55 wt. % formaldehyde and from 0.5 to 1.5 wt. % methanol are obtained, depending on the amount of added washing water. The concentrations in wt. % are in each case based on the weight of the aqueous formaldehyde solution.

Formaldehyde is marketed in the form of an aqueous solution (so-called “formalin”), formalin being supplied in various concentrations in the range from 30 to 56 wt. %. The most widely used type is formalin having a formaldehyde concentration of 37 wt. %. Formalin solutions having 32 wt. % formaldehyde, which exhibit better storage stability, are also relatively important.

As is usual in the case of commercial products, the quality of the formalin types is described by the manufacturer in a specification. The specification features indicated for formalin are usually the formaldehyde content, the methanol content and the color, for example, as the Hazen color value, and in some cases also the acidity or formic acid content. The formaldehyde content mentioned in the specification, which is usually indicated in a range of +/−0.25 wt. %, is naturally a very important parameter for the customer. During the incoming goods inspection, the customer checks that the formaldehyde content of the formalin delivery is within the specified range, in particular that it is not below the lower limit of the formaldehyde content, because he would otherwise be paying for water instead of valuable substance.

For the formalin producer, this means that it must strictly ensure that the formaldehyde content indicated in the specification is accurately maintained in the formalin delivery.

However, when preparing the aqueous formaldehyde solutions, the formaldehyde concentration can generally be adjusted and maintained only very roughly.

The state of the art is, therefore, such that the formalin production is ultimately carried out virtually batchwise by producing an amount of the aqueous formaldehyde solution with a relatively high concentration and placing it in a container. The formaldehyde content of the formaldehyde solution in the container is then determined analytically. To this end, a representative sample is usually taken and the formaldehyde content is analyzed in the laboratory by standard methods. Analysis of the formaldehyde content is usually carried out by titration according to the so-called “sodium sulfite method” (J. F. Walker, Formaldehyde, Reinhold Publishing Corp., New York 1964, p. 486).

When the formaldehyde content has been determined, the amount of water necessary to bring the amount of formaldehyde solution in the container to the specified concentration (desired concentration) of formaldehyde is then added to the container.

This practiced process is laborious, expensive and labor-intensive in respect of sampling and laboratory analyses. A disadvantage is that the process is time-consuming because, owing to the required laboratory analyses, it takes a relatively long time for the adjustment of the concentration to be completed. Another disadvantage is that smaller variations in the production process are not always detected. Because the adjustment of concentration is carried out batchwise, a plurality of containers is ultimately required, which is associated with investment and operating costs. The practiced process accordingly has considerable disadvantages.

For the preparation of aqueous formaldehyde solutions having accurately adjusted concentrations, it would be desirable to measure the formaldehyde content directly by online analysis in the absorber solution, that is, in water or in the aqueous formaldehyde solutions. There has been no lack of attempts to develop corresponding measuring processes, for example, by measuring the density or the refractive index. An important requirement for online analysis is that the online measuring process for determining the formaldehyde content achieves a degree of accuracy that is better than the deviation from the formaldehyde mean value indicated in the specification. In particular, the online measuring process must be capable of determining the formaldehyde content with a high degree of accuracy, that is to say without noticeable systematic errors, in the presence of methanol even when the methanol concentrations change. Measurements of the refractive index and of the density are ruled out as online processes because the measurements are ultimately not selective for the formaldehyde and water content and the measured value is also influenced by the methanol content. Variations in the methanol content, which can occur during the preparation process, might accordingly lead to errors in the measured formaldehyde content, which cannot be tolerated.

For the quantitative analysis of the composition of substance mixtures there are known in principle spectroscopic processes, for example, near infrared (NIR) spectroscopy, middle infrared spectroscopy and Raman spectroscopy. The analytical process near infrared (NIR) spectroscopy is a widely used technique which is employed both in the laboratory and in online operations [J. Workman; “A review of process near infrared spectroscopy”; J. Near Infrared Spectroscopy 1, 221-245 (1993)].

The advantages of the combination of NIR spectroscopy with optical waveguides over the use of middle infrared spectroscopy are known from Khettry “Inline Monitoring of Polymeric Processes”, Antec 92, 2674-2676.

For quantitative analyses, NIR spectroscopy is frequently used in combination with chemometric evaluation methods. Customary methods are, for example, the least squares method, as is described, for example, in C. Miller “Chemometrics for online spectroscopy applications—theory and practice”, J. Chemometrics 14, 513-528 (2000) or “Multivariate Analysis of Near Infrared Spectra Using G-Programming Language”, J. Chem. Inf. Comput. Sci. 40, 1093-1100 (2000). An overview of the use of multivariate chemometric calibration models in analytical chemistry is also given in “Multivariate Kalibration”, J.-P. Conzen; 2001, ISBN 3-929431-13-0.

The use of NIR techniques for specific measuring tasks is also described in WO-A-2002051898 (Produktionskontrolle bei der Herstellung von wässrigen Formaldehyd-Harzen [Production control in the preparation of aqueous formaldehyde resins]), BR 200302120 (NIR-Spektroskopic bei der Herstellung von Verbundstoff-Paneelen aus Formaldehyd-Harzen [NIR spectroscopy in the production of composite panels from formaldehyde resins]), and E: Dessipiri; Europ. Polym. J. 39, 1533-1540 (2003) (Online-NIR-Spektroskopie bei der Herstellung von Formaldehyd-Harzen [Online NIR spectroscopy in the preparation of formaldehyde resins]).

However, the possibility of using the mentioned spectroscopic methods for online determination of the concentration of formaldehyde in aqueous solutions containing formaldehyde and methanol with varying methanol contents is not known in the prior art. Correspondingly, such spectroscopic methods are likewise not used according to the prior art for the quantitative determination of the formaldehyde content in the preparation of aqueous formaldehyde solutions.

### SUMMARY OF THE INVENTION

The object of the present invention is to provide a simple and economical, continuous process for the preparation of aqueous formaldehyde solutions having a defined formaldehyde concentration, in which complex sampling and laboratory analysis can be omitted.

This and other objects which will be apparent to those skilled in the art are achieved by the process described in greater detail herein.

### BRIEF DESCRIPTION OF THE DRAWING

FIG. 1 is block diagram of an embodiment of the process of the present invention.

### DETAILED DESCRIPTION OF THE INVENTION

The present invention relates to a process for the continuous preparation of an aqueous formaldehyde solution having a formaldehyde content of from 25 to 56 wt. %, based on the weight of the aqueous formaldehyde solution, in which

a) formaldehyde is prepared by oxidation of methanol and is obtained in the form of an aqueous formaldehyde solution, and
b) the formaldehyde content of the aqueous formaldehyde solution is determined by online analysis, and
c) the determined formaldehyde content is compared with a given desired value, and
d) where appropriate, the desired formaldehyde content of the aqueous formaldehyde solution is established by addition of water.

The preparation of the aqueous formaldehyde solution in step a) can be carried out by one of the processes known from the prior art. Examples of suitable processes include:
(1) partial oxidation and dehydrogenation in the presence of crystalline silver with a deficiency of air at from 680 to 720° C. with a methanol conversion of from 97 to 98%; or
(2) partial oxidation and dehydrogenation in the presence of crystalline silver or silver nets with a deficiency of air at from 600 to 650° C. with a methanol conversion of from 77 to 87% and subsequent recovery of the methanol by distillation and its return to the process; or
(3) oxidation with iron oxide/molybdenum catalysts with an excess of air with a methanol conversion of from 98 to 99% (so-called “formox” process).

These processes are described in greater detail in G. Reuss, W. Disteldorf, O. Grundler, A. Hilt “Formaldehyde” in “Ullmann's Encyclopedia of Industrial Chemistry” 5th Edition, Vol. A 11, 624-633; VCH Verlagsgesellschaft Weinheim 1988 and in H. R. Gerberich, G. C. Seaman “Formaldehyde” in “Kirk-Othmer Encyclopedia of Chemical Technology”, 4th Edition, Vol. 11, 935-939, Wiley Interscience, New York 1994.

In the various preparation processes, the formaldehyde is in each case obtained in the form of an aqueous solution usually having a concentration of from 25 to 56 wt. %, preferably from 30 to 50 wt. %, based on the weight of the solution.

In the silver contact and metal oxide contact processes, the hot reaction gases, which consist substantially of the formaldehyde that has formed, unconverted methanol, water, CO₂, CO, CH₄, oxygen, hydrogen and nitrogen, are cooled after the reaction. The resulting formaldehyde is then washed with water or dilute formaldehyde solution. Washing is conventionally carried out in a plurality of stages counter-currently in an absorption column. The heat of absorption that is released is dissipated in heat exchangers via a product loop and can be used in a different location for heating.

The washing liquid is generally applied at the head of the last absorption stage. The formaldehyde concentration can roughly be adjusted via the amount of washing liquid.

In the process with complete methanol conversion, in the first absorption stage a 40 to 42 wt. %, based on the weight of the solution formaldehyde solution is usually obtained. The formaldehyde concentration is lower in the subsequent absorption stages.

The aqueous formaldehyde solutions still contain residual amounts of methanol (about 1 wt. % in the process with complete methanol conversion). In the process with incomplete methanol conversion, the methanol content of the absorption solution is usually from 5 to 15 wt. %. In order to separate off the methanol, the methanol-containing formaldehyde solution is subsequently distilled. Formaldehyde solutions having a concentration of about 50 wt. % (from 45 to 55 wt. %) and from 0.5 to 1 wt. % methanol are then usually obtained.

In the formox process, formalin solutions having a concentration of from 37 to 55 wt. % formaldehyde and from 0.5 to 1.5 wt. % methanol are obtained, depending on the amount of added washing water. The concentrations in wt. % are in each case based on the weight of the aqueous formaldehyde solution.

In step b), the determination of the formaldehyde content of the aqueous formaldehyde solution by online analysis is carried out. The starting point of the present invention is the finding that, for example, the NIR absorption spectra of formaldehyde/water/methanol mixtures are, surprisingly, sufficiently different from one another, even in the case of relatively small differences in the formaldehyde concentration, that the formaldehyde concentration in formaldehyde/water/methanol mixtures can be determined from the spectrum with the aid of a chemometric calibration model having the required accuracy, even in the case of varying methanol contents.

Preferably, the determination of the formaldehyde content of the aqueous formaldehyde solution in step b) is carried out in a manner such that a spectrum of the aqueous formaldehyde solution is recorded online by an optical sensor by means of near infrared (NIR) spectroscopy, middle infrared spectroscopy or Raman spectroscopy. The measured spectrum is then preferably entered into a chemometric calibration model which has previously been prepared for formaldehyde/water/methanol mixtures with different concentrations and ratios of the individual components. By evaluation using the chemometric calibration model, the concentrations of formaldehyde, water and methanol in the formaldehyde/water/methanol mixture (aqueous formaldehyde solution) are obtained. The chemometric calibration model can preferably be a multivariate model, for example, based on a partial least squares algorithm.

A suitable analytical method is, in particular, NIR spectroscopy. A particular advantage of NIR spectroscopy is that the spectra can be recorded online in the process stream by means of light guides. The NIR radiation is beamed into the process stream by means of a light guide via a probe and then, after absorption, is fed back to the detector of the NIR spectrometer via light guides. Detection takes place in the near infrared range. The overtone and combination vibrations that occur are evaluated by means of statistical methods. Preferred ranges for evaluation of the spectrum are the ranges from 9000 cm⁻¹ to 8000 cm⁻¹ and from 6500 cm⁻¹ to 5400 cm⁻¹, preferably the range from 6200 cm⁻¹ to 5500 cm⁻¹. The measurement can be carried out directly in the process stream or alternatively in a partial stream which is diverted from the process stream.

Online measurement within the scope of the process according to the invention means that a measurement is carried out at least once per minute, preferably at least once per 10 seconds, most preferably at least once per second.

The person skilled in the art is familiar with NIR spectroscopy and also with suitable evaluation methods, such as chemometric evaluation methods, for example from the above-mentioned literature references.

Preferably, in the process of the present invention, the methanol content of the aqueous formaldehyde solution is simultaneously determined in step b) in addition to the formaldehyde content. The above-mentioned analytical methods are capable of such determination.

Measurement of the formaldehyde content and optionally of the methanol content of the aqueous formaldehyde solution in step b) can be carried out at various locations. For example, the measurement can be carried out in the outlet from the absorption column, or in the pipe leading to the container in which the aqueous formaldehyde solution is collected or stored, or in a bypass of such a container.

In step c), the determined formaldehyde content is compared with a given desired value. Preferably, the formalin volume stream whose concentration is to be adjusted is measured. Then, if required, water is added to the formalin volume stream in the ratio necessary to obtain the target concentration. This takes place in step d), which is carried out if the determined formaldehyde content is greater than the given desired value for the formaldehyde content. The formalin-to-water ratio that is to be established is advantageously calculated by comparing the calculated actual formaldehyde concentration (the formaldehyde content actually measured) with the specified desired formaldehyde concentration (the desired or specified formaldehyde content).

There is preferably established in step a) a formaldehyde content of the aqueous formaldehyde solution such that the addition of water is required in any case in step d). However, it is also conceivable in the rarer case that no further correction is necessary.

It is particularly advantageous if, in step b), the methanol content of the aqueous formaldehyde solution is also determined simultaneously in addition to the formaldehyde content. Because, if increased methanol contents are measured in the aqueous formaldehyde solution, it is possible to intervene in the preparation process in step a) and adapt production or installation parameters for the preparation process in step a) so that the methanol content comes into the preferred range. Trends can also be recognized. The production of batches that do not meet specifications and of batches with reduced product quality is thus largely avoided.

A further advantage of the present invention is that manual sampling and subsequent laboratory analysis in respect of methanol analysis can also be omitted.

Another advantage is the possibility of automatic process management in the adjustment of the formaldehyde concentration on the basis of the concentration information for formaldehyde and methanol in the aqueous formaldehyde solution produced in step a). This also allows a virtually constant product quality to be maintained. Formalin preparation, including the adjustment in step d) of the formaldehyde content of the aqueous formaldehyde solutions produced, is thus possible in a fully continuous process.

The process according to the invention can also advantageously be used to prepare individual batches if the aqueous formaldehyde solution obtained in step d) is subsequently collected in containers.

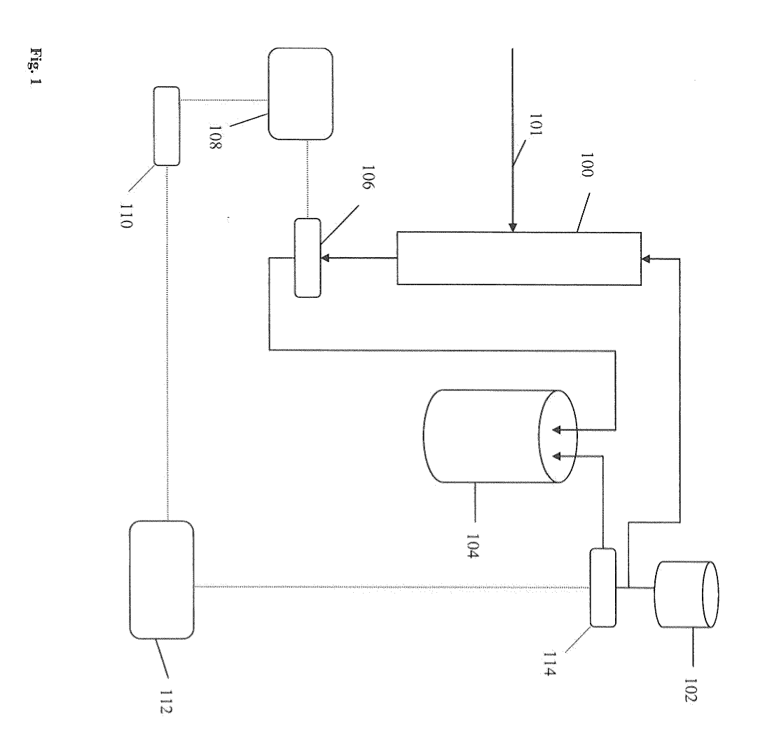

The invention is explained in detail hereinbelow with reference to the FIGURE. FIG. 1 shows in the form of a block diagram an embodiment of the process of the present invention for the preparation of an aqueous formaldehyde solution with continuous addition of water in order to establish the desired formaldehyde concentration.

The mixture 101 produced by partial oxidation or dehydrogenation of methanol and containing formaldehyde as well as water and methanol is washed in an absorption device 100 with water from tank 102. An optical measuring cell 106 is fitted in the pipe between the absorption device 100 and the storage tank 104, which measuring cell 106 contains an

NIR (near infrared) sensor. The measuring cell 106 is preferably connected to the spectrometer 108 by way of an optical waveguide. The spectrometer 108 supplies a spectrum, which is entered into a chemometric calibration model 110 (comprising a device in which the calibration model is implemented and used). The chemometric calibration model 110 can be formed by a separate evaluation unit, for example a commercially available computer. Alternatively, the spectrometer 108 can itself comprise such an evaluation unit for the spectrum.

As the result of the analysis of the measured spectrum, the chemometric calibration model 110 indicates the actual content of formaldehyde and methanol in the aqueous formaldehyde solution. The actual formaldehyde content is entered into a controller 112, in which the desired formaldehyde content is stored. From a difference between the actual and the desired formaldehyde content, the controller 112 determines a correcting variable for the pump control of the pump 114 for adding the stream of water from the tank 102 to the storage tank 104. The measuring cell 106 can, for example, also be incorporated into the storage tank 104, for example, into a recirculation pipe.

The controller 112 can be formed by a process control system of the formaldehyde preparation installation. If the formaldehyde content or methanol content is outside the range specified for the preparation process, a message is preferably given.

The continuous lines in FIG. 1 denote the substance flow of the aqueous formaldehyde solution or of the water. The dotted lines denote the flow of data and information, for example, between the measuring cell 106 and the spectrometer 108 or between the calibration model 110 and the controller 112.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A continuous process for producing an aqueous formaldehyde solution having a formaldehyde content of from 25 to 56 wt. %, based on weight of aqueous formaldehyde solution comprising:
a) oxidizing methanol to produce an aqueous formaldehyde solution, and
b) determining formaldehyde content of the aqueous formaldehyde solution by online analysis,
c) comparing the formaldehyde content determined in b) with a desired formaldehyde content, and
d) optionally, adding water to obtain the desired formaldehyde content in the aqueous formaldehyde solution.

2. The process of claim 1 in which in b), a spectrum of the aqueous formaldehyde solution is recorded and entered into a chemometric calibration model.

3. The process of claim 2 in which the spectrum is a near infrared spectrum, a middle infrared spectrum or a Raman spectrum.

4. The process of claim 1 in which methanol content of the aqueous formaldehyde solution is also determined in b).

5. The process of claim 4 in which methanol content of the aqueous formaldehyde solution is determined by online analysis.

6. The process of claim 1 in which the formaldehyde content determined in step b), is used to control step a).
